(19) United States
(12) Patent Application Publication
(10) Pub. No.: US 2010/0143567 A1
(43) Pub. Date: Jun. 10, 2010

(54) DAIRY PRODUCT AND PROCESS

(75) Inventors: Aiqian Ye, Palmerston North (NZ); Stephen Murray Taylor, Palmerston North (NZ)

Correspondence Address: KNOBBE MARTENS OLSON & BEAR LLP, 2040 MAIN STREET, FOURTEENTH FLOOR, IRVINE, CA, 92614, US

(73) Assignee: FONTERRA CO-OPERATIVE GROUP LIMITED, Auckland (NZ)

(21) Appl. No.: 12/597,485

(22) PCT Filed: Apr. 24, 2008
(86) PCT No.: PCT/NZ08/00089

§ 371 Date: Jan. 26, 2010

(30) Foreign Application Priority Data
Apr. 24, 2007 (NZ) 554743

(51) Int. Cl. A23D 7/04; A23D 7/005

(52) U.S. Cl. 426/603

(57) ABSTRACT

A viscoelastic fluid is prepared by shearing a gelled emulsion. The emulsion is an oil-in-water emulsion comprising 2% 12% (w/w) of a heat-treated protein that can form a heat-set gel and 5% 40% fat. The proteins used include whey protein and soy protein. The viscoelastic fluid may be used as a spread. It may also be used for the preparation of a plurality of different ultimate products formed from the original gel.

### TECHNICAL FIELD

The invention relates to protein emulsion compositions and processes for their preparation. The compositions may be used in or as foods.

### BACKGROUND ART

Food with a gel-like consistency may be obtained by including within an aqueous medium, a thickening agent. A variety of high molecular whey compounds have been used to form gels in foods. For example, starch, gums, pectins, and gelatines.

Egg proteins are frequently used for their thickening properties and also for their emulsifying properties. Eggs are expensive and require careful handling because of risks of contamination.

For thickening oil-in-water emulsions, one method involves use of whey proteins, which are commercially available in the dry state. U.S. Pat. No. 4,720,390 describes a process for producing a gelled food product where an oil-in-water emulsion is prepared from an aqueous medium and a lipidic medium. The emulsion contains 4-12% weight w/v of gellable whey proteins and 2.5-40% by volume of the lipidic medium. The process is characterised in that the aqueous medium is homogenised with a lipidic medium under such conditions that the emulsion formed contains a homogenous series of fat globules having a diameter of from 140-6000 nm and a mean diameter of less than 1000 nm. The emulsion is heat treated to form the gel. U.S. Pat. No. 4,720,390 teaches nothing about further processing of this gelled emulsion.

Hunt & Dalgleish (J. Food Sci. 60, 1120-1131 (1995) prepared emulsions containing 20% soy bean oil made with 2% whey protein isolate (WPI) and a heat treatment. The resulting emulsions where described as stable. Direct heating is possible, for example infusion of high pressure steam. Hunt & Dalgleish do not describe any further processing of the heat-treated emulsion.

U.S. Pat. No. 6,419,975 describes a process for producing making caseinless cream cheese-like products using whey protein stabilized emulsion. The whey protein stabilized emulsion was heated to form the denatured protein-stabilized emulsion, which means an emulsion system containing denatured proteins and stabilized by a protein matrix in which water molecules are trapped in the matrix. It indicates that gel is formed after heating. This gel was adjusted pH to 4 to 6 with food grade acids. The pH-adjusted emulsion passes to a second homogenization to form the cream cheese-like product.

It is an object of the present invention to provide a spread-like emulsion that has heat stable and thixotropic properties, or to at least provide the public with a useful choice.

### DISCLOSURE OF THE INVENTION

In one aspect, the invention provides a method for preparing a viscoelastic fluid comprising:
(a) mixing oil or fat or a mixture of oil and fat with an aqueous medium to form an oil-in-water emulsion comprising 2% to 12% (w/w) of protein that can form a heat-set gel and 5% to 40% (w/w) oil or fat or a mixture of oil and fat, and homogenising the mixture at a pressure in the range 100 to 2000 bar;
(b) heating the homogenised emulsion to 50° C. to 200° C. without allowing a gel to farm, for a period sufficient to denature the proteins;
(c) optionally cooling;
(d) allowing the heat-treated emulsion to form a gel by a method selected from adding a salt, and acidification; and
(e) subjecting the gel to shearing to form a viscoelastic fluid.

In another aspect, the invention provides a method of preparing a viscoelastic fluid comprising forming an oil-in-water emulsion by mixing oil or fat with an aqueous medium and homogenization at pressure in the range 100 to 2000 bar, wherein the mixture comprises 2-12% (w/w) protein and 5-40% (w/w) oil or fat. The emulsion is heated to 50-200° C. in the presence of a salt for a period sufficient to form the emulsion gel. Following the heat-treatment and optional cooling, the emulsion gel is subjected to shearing for example by high speed blending, high speed stirring, or homogenisation to form a viscoelastic fluid.

Alternatively, an emulsion gel comprising forming an oil-in-water emulsion is prepared by mixing oil or fat with an aqueous medium and homogenization at pressure in the range 100 to 2000 bar, wherein the mixture comprises 2-12% (w/w) protein and 5-40% (w/w) oil or fat. The emulsion is heated to 50-200° C. for a period sufficient to denature the proteins. Following the heat treatment and optional cooling, the emulsion gel is formed when salt (Ca²⁺ or Na⁺) is added to the emulsion or the emulsion is acidified to pH<5.5, e.g., by addition of Glucono-δ-lactone (GDL), or other food grade acids or fermentation. The emulsion gel is subjected to shearing for example by high speed blending, high speed stirring, or homogenisation to form the viscoelastic fluid.

FIG. 1 gives flow diagrams of methods of these types.

Alternatively, the protein (for example, whey protein) may be heat treated before mixing with the oil to form the emulsion. In this alternative, aqueous protein is heated to 50-200° C. for a period sufficient to denature the proteins and then mixed with oil or fat and homogenization at pressure in the range 100 to 2000 bar to form the oil-in-water emulsion, wherein the mixture comprises 2-12% (w/w) whey protein and 5-40% (w/w) oil or fat. Following the homogenization, the emulsion gel is formed when a salt (providing, for example, Ca²⁺ or Na⁺) is added to the emulsion or the emulsion is acidified to pH<5.5, preferably <5, e.g., by addition of Glucono-δ-lactone (GDL), or other food grade acids or fermentation. The emulsion gel is subjected to shearing, for example, by high speed blending, high speed stirring, or homogenisation to form the viscoelastic fluid (FIG. 2).

The viscoelastic fluids produced by invention may or may not have a yield stress. They are typically relatively whipped cream-like, heat stable, and have thixotropic properties. The viscosity and the rheological properties of cream-like product show only small changes over a wide temperature range of 4° C. to 90° C. The viscosity of the cream-like product decreases with increasing shear rate, and the viscosity of the product returns to initial after the shear is removed (it is thixotropic). This allows preparation of bulk gels which are then sheared and distributed to packaging before the viscosity returns to that of the unsheared state. This method allows use of gel for the preparation of a plurality of different ultimate products formed from the original gel. The viscoelastic fluids having yield stress can be useful for suspending inclusions with densities different from the fluid itself. For example, the sheared gel might be distributed to a plurality of containers containing fruit of different types. The viscosity increases upon removal of shear, allowing production of products with a number of different flavours.

In some embodiments, viscoelastic fluids may be spread over a porous surface such as a bread surface without soaking into the porous surface. Such fluids are useful as spreads.

The protein can be from the group of proteins of animal or vegetable origin that form gels upon heating, such as whey proteins, soy proteins, myofibrillar (skeletal/meat) proteins, egg proteins and blood proteins (Ziegler G. R. & Foegeding E. A. (1990). Advances in Food and Nutrition Research, vol 34, 203-298) most preferably whey proteins, soy proteins, meat proteins.

Preferably, the protein content of the emulsion is 2-10% (w/w), more preferably 2-8%.

Preferably the protein is whey protein or soy protein or a mixture of both, most preferably whey protein. Most preferably, the whey proteins are provided from a whey protein isolate (WPI) or a whey protein concentrate (WPC).

A whey protein concentrate (WPC) is a whey fraction in which at least 35%, preferably at least 50% (w/w) of the total solids comprises whey proteins. WPCs are generally prepared by ultrafiltration and/or diafiltration of whey. Preferably, the protein composition is substantially that of the whey from which it is derived. WPCs can be in the form of liquid concentrates or dried powders.

A whey protein isolated (WPI) is a whey fraction in which at least 90% (w/w) of the total solids comprise whey proteins. WPIs are generally prepared by microfiltration or ion exchange in combination with ultrafiltration and/or diafiltration of whey. Again, the protein composition is preferably substantially that of the whey from which it was derived. WPIs can be in the form of liquid concentrates or dried powders.

Preferably, the oil or fat is present in an amount from 7-35%, more preferably 10-25% w/w. Preferably, the oil is vegetable oil, for example, soy bean oil, sunflower oil, olive oil, canola oil, or peanut oil, and the fat is milk fat. Those who are skilled in the art would understand that many other oils or fat can be used. Mixing may be carried out in any manner suitable for producing the water-in-oil emulsion. Normally this is carried out by homogenisation in a 1- or 2-stage homogeniser.

The length of the heat treatment is usefully varied depending on the temperature of the heat treatment. Shorter heat treatments may be used at the higher temperatures.

Preferred temperatures are in the range 70-200° C., more preferably 80-150° C. A 145° C. heating time of 5 seconds-30 minutes may be used whereas at 80° C. a heating time of 20 minutes-60 minutes is preferred. The presence of inorganic cations also influence the amount of heat treatment required.

Gel formation can be enhanced by including within the emulsion or the mixture used to form the emulsion, inorganic ions. Especially preferred are calcium ions and sodium ions. Addition of these ions allows use of lower concentrations of a protein and/or lower temperatures in the heat treatment steps. For sodium chloride, addition of sufficient salt to provide a concentration of exogenous sodium chloride of 10-300 mM is preferred, more preferably 100-200 mM. Lower concentrations of calcium chloride may be used, with the preferred concentrations being in the range 4-20 mM, often 4-12 mM.

The whey protein source that is currently preferred is a WPI if higher firmness is required.

The products produced from the sheared emulsion gel of the invention vary in firmness according to the pH of the end product. The pH may be unchanged from that of the gel sheared. In that case, the pH of the gel sheared may be in the range 4.0-7.5, preferably 4.0-7.0. When a more viscous product is preferred, a pH in the range 5.5-7.5 or 4.0-4.5 is preferred. At intermediate pHs, around pH 5, the firmness is lower. The less firm sheared gels are of course useful in low pH products such as yoghurt. A pH around 5 should be avoided if possible, where a high viscosity is required to add texture to a product. However, while the pH of the product may reflect that of the gel that is sheared, it is also preferred in some applications to modify the pH during the process, for example by acidifying the sheared gel, especially to obtain the pH values described as preferred above.

For emulsion gel formed from pre-heated emulsion or heated protein-formed emulsion with addition of salt or adjusting pH to lower than 5.5 (processes 2, 3 in FIG. 1 and FIG. 2), the preferred concentration of calcium chloride is in the range 4-100 mM. The pH may be in the range 4.0-6, lowering the pH would be associated with formation or strengthening of the gel.

Other ingredients may be included in the gel. One example is sugar, useful in preparing gel desserts. The components added may affect the gel strength. Increasing sugar concentration can increase gel firmness, possibly due to the increasing total solids in the emulsion. The homogenisation pressure can be varied to vary the gel strength. Homogenisation pressure of 100-2000 bar is preferred for strong gels, preferably higher than 300 bar. The average droplet size of emulsions is preferably controlled at smaller than 1 μm or the droplet size distribution are between 0.05 to 10 μm.

For the effect of inorganic ions on gel formation, it is not necessary that they be present during the heating step. The inorganic ions may be added to the treated emulsion after cooling. Alternatively, where the emulsion is not heated but instead is prepared from heated whey protein mixed with oil that has not been heat treated, the inorganic ions may be added during or after the emulsification step. pH adjustment may also be used to cause gelation or strengthen gels. The addition of an acidulant such as glucono-delta-lactone (GDL) or fermentation may be used to decrease the pH lower than pH 5.0. Lowering the pH would be associated with formation or strengthening of the gel.

In preferred embodiments flavouring is included in the mixture to be emulsified and/or in the emulsion before it gels. The emulsions may be used to make mayonnaise, dips, sauces, spreads, sour creams, cultured creams and additives for soups. Flavourings are chosen according to the desired type of product. For example, vinegar is included in the emulsion for the manufacture of mayonnaise.

Gelling occurs when the storage modulus G′ is greater than the loss modulus G″ and is generally recognisable to those skilled in the art. Denaturation of the heat-setting proteins can be assessed by native polyacrylamide gel electrophoresis by methods known to those skilled in the art. It is generally associated with molecular weight increase.

The term ‘comprising’ as used in this specification and claims means ‘consisting at least in part of’, that is to say when interpreting statements in this specification and claims which include that term, the features, prefaced by that term in each statement, all need to be present but other features can also be present. Related terms such as ‘comprise’ and ‘comprised’ are to be interpreted in similar manner.

### BRIEF DESCRIPTION OF THE DRAWINGS

FIG. 1 shows the schematic diagram of the processes of the invention.

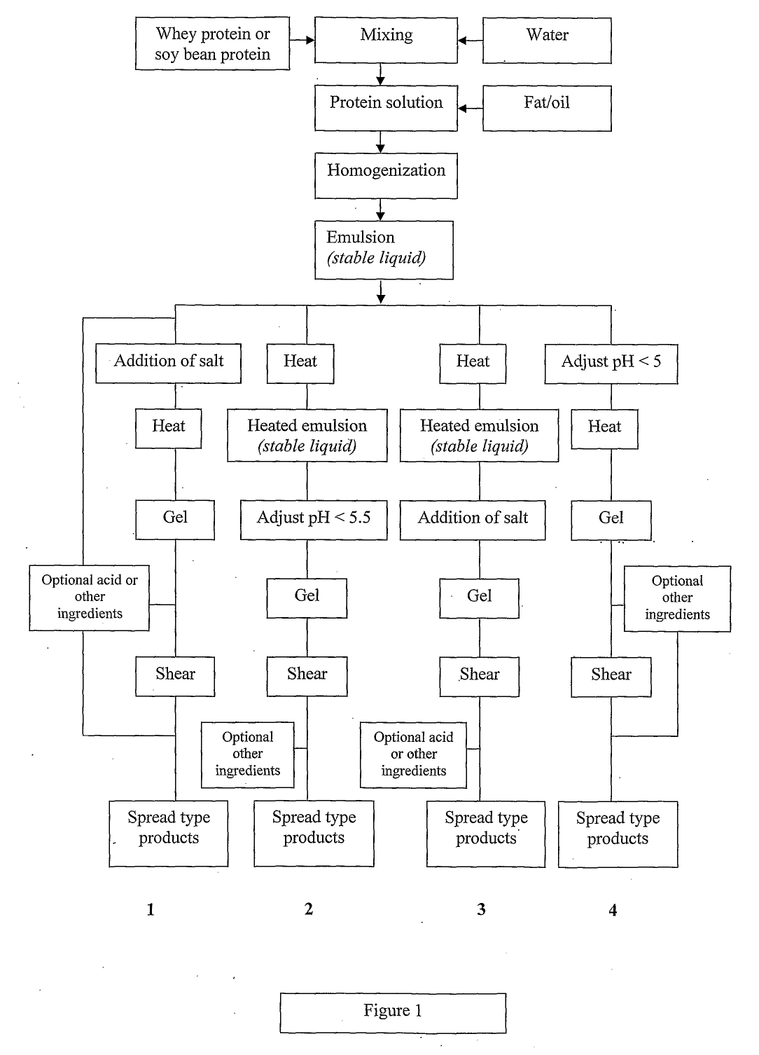

FIG. 2 shows the schematic diagram of the processes of the invention, in which emulsion made with heated protein.

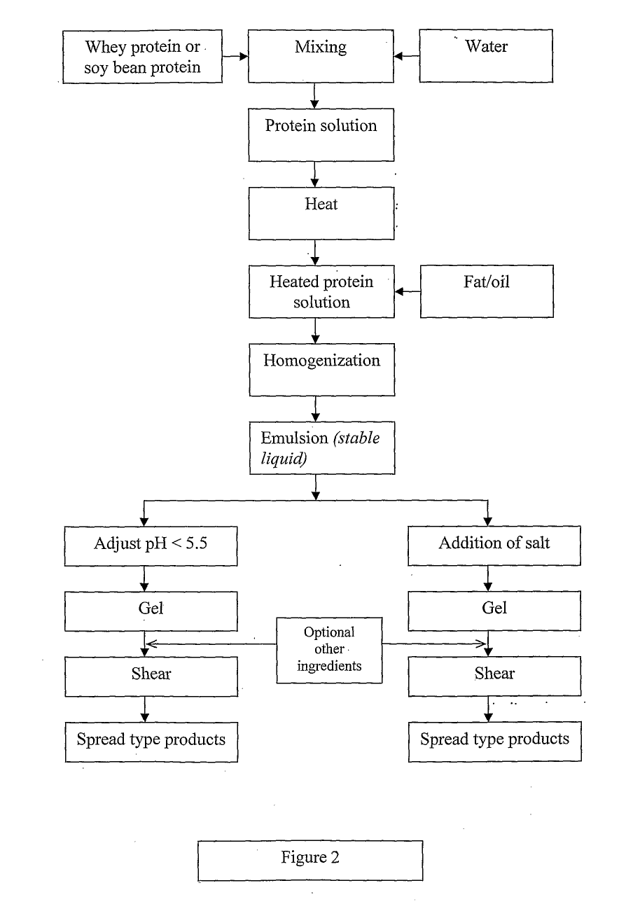

FIG. 3 shows the changes in storage modulus (G′, ) and loss modulus (G″, ∘) of sheared emulsion gel (2.4% whey protein (A392) and 10 w/w % milk fat, and 200 mM NaCl) (top) during a frequency sweep (0 to 10 Hz) at room temperature, and (bottom) during a temperature sweep (20 to 90° C.).

FIG. 4 shows the changes in storage modulus (G′, ) and loss modulus (G″, ∘) of sheared emulsion gel (2.4% whey protein (A392) and 10 w/w % sunflower oil, and 200 mM NaCl) (top) during a frequency sweep (0 to 10 Hz) at room temperature, and (bottom) during a temperature sweep (20 to 90° C.).

FIG. 5 shows the changes in viscosity of sheared emulsion gel (2.4% whey protein (A392) and 10 w/w % milk fat (top) or sunflower oil (bottom), and 200 mM NaCl) during a shear sweep (0 to 1000 s⁻¹) at room temperature

FIG. 6 shows the changes in viscosity of sheared emulsion gel (2.4% whey protein (A392) and 10 w/w % sunflower oil, and 200 mM NaCl) at room temperature (˜20° C.) after a shear sweep (0 to 1000 s⁻¹) and holding for 10 min, then the viscosity was measured at 0.01 s⁻¹ over a period of 2 hours.

FIG. 7 shows the viscosity at a shear rate of 53.3 s⁻¹ of the acid gels comprising WPI sheared emulsion gels made with 3.6% protein (WPC A895) and 10 w/w % milk fat (AMF).

### EXAMPLES

The following examples further illustrate practice of the invention.

### Materials and Methods

The following materials and methods were generally used in the examples listed below. The use of specific material and deviation from these general methods are specifically mentioned for each example.

### Sources of Protein

Commercial whey protein concentrates containing 80% protein were manufactured from cheese whey (ALACEN 392, A392) or acid casein whey (ALACEN 342, A342) by Fonterra Co-operative Group Limited.

Commercial whey protein isolate (ALACEN 895, A895) containing 90% protein was manufactured by Fonterra Co-operative Group Limited.

Commercial soy protein isolate (6000) containing 90% protein was manufactured by Protient.

### Sources of Fat

Fat products were sun flower oil (from super market), soy oil (from super market), and anhydrous milk fat, AMF (a commercial product)

### Salts

NaCl and CaCl₂, both were of analytical grade.

### Water

The water used in all the experiments was purified using Milli-Q system, Millipore Corp., Bedford, Mass. 01730, USA; control.

### Preparation of Oil-Water Emulsions

Whey protein solutions (pH ˜6.9) were prepared, so that upon mixing with various quantities of oil the final protein concentrations of 1-12%, w/w, were achieved, by dissolving one of the protein powders in water at 50° C. and stirring for 30 min. The protein solutions were then mixed with oil or fat so that the final mixture contained 2.5 to 40% (w/w) oil/fat.

To make stable emulsions, the mixtures were homogenized at 50° C. in a two stage homogenizer, first stage and a second-stage pressures of 400 and 50 bar respectively. The mixtures were passed through the homogenizer three times to form the fine emulsions with an average size (d₃₂) of about 0.2 μm. Salt (NaCl or CaCl₂) was then added at various levels and stages depending on the specific aims of each experiment.

Preparation of Sheared Emulsion Gels

The emulsions were filled into glass containers or metal cans and were then heated in a water bath at 90° C. for 30 minutes or retorted at 121° C. for 16 min. An emulsion gel is then formed after cooled down to the room temperature in a water bath. A cream-like sheared emulsion gel is formed after the emulsion gel is blended in a high speed blender. The cream-like emulsion gels were used for sensory evaluation or rheological measurements.

### Dynamic Rheological Measurements

Dynamic oscillatory viscoelasticity of the emulsion gels was investigated at low strain using a controlled stress rheometer (Physica MCR301, Anton Paar, Germany) fitted with a 25 mm parallel plate with 2.0 mm gap. the samples were placed on the lower plate and covered with a thin layer of low viscosity mineral oil to prevent evaporation. For the temperature sweep, the sample was then heated in situ at a rate of 2° C./min from 20 (or 5° C.) to 95° C. and cooling at a rate of 3° C./min from 95 to 20° C. All measurements were made in the linear viscoelastic region (0.5% strain) and at a constant frequency of 1 Hz. The steady-shear measurements were performed by varying the shear stress from 0.01 to 3900 Pa which corresponds to the rheometer range limits for the geometry used. All the measurements were made in duplicate at a constant temperature of 20° C.

### Example 1

### Preparation of Sheared Spread-Like Emulsion Gels

Emulsion was prepared using 2.4% protein (WPC A392) and 10 w/w % milk fat or sunflower oil. After the homogenising the mixture, 150 mM (0.88%) NaCl was added to emulsion. Emulsion in the presence of NaCl was then filled into metal cans and retorted at 121° C. for 16 min. The emulsions were then cooled down to room temperature in a water bath. The emulsion gel was removed and then blended or stirred in a high speed blender. A cream-like or paste-like gel was formed. This cream-like gel was described to be stable with no syneresis over along period of time (more than two weeks).

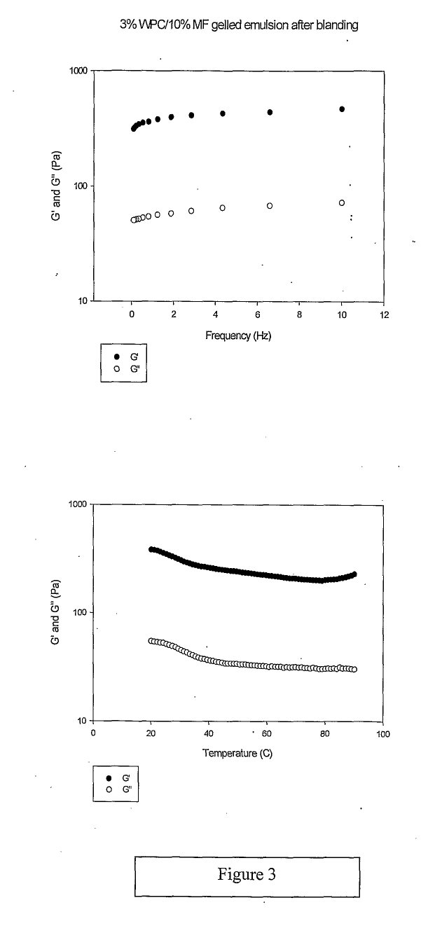

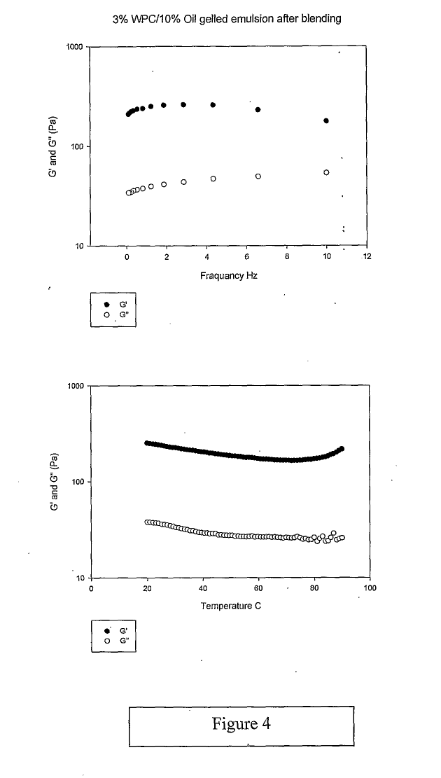

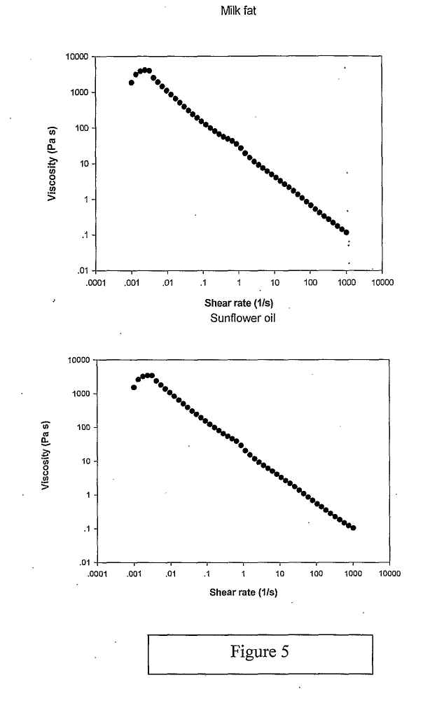

The rheological properties of the cream-like sheared emulsion gels were determined using the methods described above. FIGS. 3 and 4 demonstrate that the cream-like sheared emulsion gels formed using milk fat and sunflower oil behaved similarly, i.e. the texture in both cream-like sheared emulsion gels was stable over wide ranges of frequencies (0 to 10 Hz) and temperatures (20 to 90° C.). FIG. 5 demonstrates that both cream-like gels (made from milk fat and sunflower oil) behaved similarly (shear thinning) under a wide range of shear rates (0 to 100 s⁻¹).

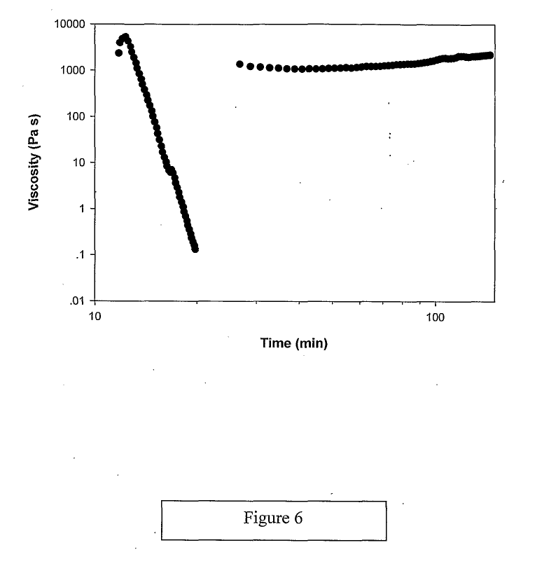

FIG. 6 shows the changes in the viscosity of the cream-like sheared emulsion gel (made from sunflower oil) after being subjected to shear sweep (0 to 100 s⁻¹). The sample was held for 10 min and then the viscosity was measured at OA over a period of time (˜2 hrs). The results demonstrate that the cream-like sheared emulsion gels are shear thinning but upon holding the original texture is restored.

These results demonstrate that the creamed emulsion can be processed via high-flow systems such as in pumps and packed. Upon storage, the texture of the cream can be restored.

### Example 2

### Preparation of Shear Spread Like Gel from Emulsions Made with Different Protein Sources

Emulsions consisting of 3% protein using WPC (A392), WPC (A342), WPI (A895), or SPI and 10% milk fat and 150 mM NaCl were prepared using the same conditions as in Example 1. The firmness (G′) and viscosity, measured described in the Materials and Methods section above, of spread-like sheared gels at 20° C. is shown in the Table 1. The results show that the shear spread-like sheared gel made with WPCs (A392 and A342) had similar gel firmness and viscosity. The sheared gel made with WPI had much higher firmness, and product made with UF whey retentate had higher firmness than that of gel made with WPCs, but SPI sheared gel had a much lower firmness and viscosity.

This example demonstrates that various levels of product firmness and viscosity can be achieved from choosing different protein source.

TABLE 1
Firmness (G′) and viscosity of shear spread-like sheared gel made
with emulsions formed with different protein sources under
heat treatment.

| Protein source | Firmness G′ (Pa) | Viscosity (Pa s) |
|---|---|---|
| WPC A392 | 302 | 1120 |
| WPC A342 | 387 | 1910 |
| WPI A895 | 3510 | 21900 |
| Whey retentate | 355 | 1632 |
| SPI | 202 | 665 |

### Example 3

### Preparation of Spread-Like Sheared Gel from Emulsions Made with Different Lipid Sources

The sheared gels made from emulsions containing 3% protein (A392) and 10 w/w % soy bean oil, milk fat (AMF) or fresh cream were prepared using the same conditions described at example 1. The firmness (G′) and viscosity, measured described in the Materials and Methods section above, of spread-like gels sheared at 20° C. is shown in the Table 2.

This example demonstrates that sheared spread like gels can be formed from different oil/fat source. It can be used to achieve a desired formulation in a product by choosing different oil/at source.

TABLE 2
Firmness (G′) and viscosity of sheared spread-like gel made with
emulsions formed with different lipid sources under heat treatment.

| Protein source | Firmness G′ (Pa) | Viscosity (Pa s) |
|---|---|---|
| Soy bean oil | 242 | 1070 |
| Milk fat (AMF) | 302 | 1120 |
| Fresh cream | 286 | 1135 |

### Example 4

### Preparation of Spread-Like Sheared Gel from Emulsions Made with Different Concentrations of Protein

Emulsions containing different protein (WPC A392) concentrations and 10 w/w % milk fat (AMF) were prepared using the same conditions described at example 1. The firmness (G′) and viscosity, measured described in the Materials and Methods section above, of spread like gels at 20° C. is shown in the Table 3.

This example demonstrates that shear spread like gels can be formed at different protein levels and can be used to achieve a desired texture in a product by controlling protein contents.

TABLE 3
Firmness (G′) and viscosity of shear spread-like gel made with
emulsions formed with different protein concentrations under
heat treatment.

| Protein concentration (%) | Firmness G′ (Pa) | Viscosity (Pa s) |
|---|---|---|
| 2.4 | 267 | 784 |
| 3.0 | 302 | 1120 |
| 4.0 | 1563 | 5612 |
| 6.0 | 2087 | 9640 |
| 8.0 | 2601 | 1292 |

### Example 5

### Preparation of Spread-Like Sheared Gel from Emulsions Made with Different Concentrations of Fat

Emulsions containing 3% WPC (A392) and different milk fat (AMF) concentrations were prepared using the same conditions described at example 1. The firmness (G′) and viscosity, measured described in the Materials and Methods section above, of spread-like sheared gels at 20° C. is shown in the Table 4.

This example demonstrates that shear spread like gels can be formed at different fat levels and can be used to achieve a desired texture in a product by controlling fat contents.

TABLE 4
Firmness (G′) and viscosity of shear spread-like sheared gel made
with emulsions formed with different fat concentrations under
heat treatment.

| Fat concentration (%) | Firmness G′ (Pa) | Viscosity (Pa s) |
|---|---|---|
| 7 | 152 | 458 |
| 10 | 302 | 1120 |
| 15 | 1163 | 7612 |
| 20 | 3024 | 11960 |

### Example 6

### Preparation of Spread-Like Sheared Gel from Heated Emulsions at Acidic Conditions

Emulsions containing 3% protein (whey protein UF (ultrafiltration) retentate, WPC A392, WPI A895, SPI (soy protein isolate) and 10% w/w, milk fat (AMF), were heated at 90° C. for 30 min, and then cooled down to room temperature in a cold water bath. 1% GDL was then added emulsions at 20° C. The emulsions formed the set gel when pH of emulsions decreased to about pH4.7 for about 5 hours. The emulsion gel were blended or stirred in a high speed blender. The cream-like or spread-like sheared gels were formed.

The firmness (G′) and viscosity, measured described in the Materials and Methods section above, of spread like gels at 20° C. is shown in the Table 5.

The firmness and viscosity of sheared gel obtained from emulsions is: WPI>SPI>UF retentate>WPC. This example indicates the spread-like sheared gel can be produced from the pre-heated emulsions made with different protein sources at pH<5. This example demonstrates that various levels of sheared gel firmness can be achieved from choosing different protein sources at acidic conditions.

TABLE 5
Firmness (G′) and viscosity of spread-like sheared gel made with
emulsions formed with different protein sources under acidic condition.

| | pH of sheared | | |
|---|---|---|---|
| Protein source | gel | Firmness G′ (Pa) | Viscosity (Pa s) |
| WPC A392 | 4.55 | 251 | 616 |
| WPI A895 | 4.7 | 1730 | 4503 |
| Whey retentate | 4.6 | 312 | 956 |
| SPI | 4.6 | 759 | 2541 |

### Example 7

### Preparation of Spread-Like Sheared Gel from Heated Emulsions after Addition of CaCl₂

Emulsions containing 3% protein (whey protein UF (ultrafiltration) retentate, WPC A392, WPI A895, SPI (soy protein isolate) and 10% w/w, milk fat (AMF), were heated at 90° C. for 30 min, and then cooled down to room temperature in a cold water bath. CaCl₂ (20 mM) was then added emulsions at 20° C. The emulsions formed the set gel after 10 min. The emulsion gel were blended or stirred in a high speed blender. The cream-like or spread-like sheared gels were formed.

The firmness (G′) and viscosity, measured described in the Materials and Methods section above, of spread-like sheared gels at 20° C. is shown in the Table 6.

TABLE 6
Firmness (G′) and viscosity of spread-like sheared gel made with
emulsions formed with different protein sources after addition of CaCl₂.

| | pH of sheared | | |
|---|---|---|---|
| Protein source | gel | Firmness G′ (Pa) | Viscosity (Pa s) |
| WPC A392 | 6.5 | 301 | 1023 |
| WPI A895 | 6.6 | 1360 | 3990 |
| Whey retentate | 6.7 | 348 | 1369 |
| SPI | 6.6 | 635 | 2871 |

The firmness and viscosity of the sheared gel obtained from emulsions is: WPI>SPI>UF retentate>WPC. This example indicates the spread-like sheared gel can be produced from the pre-heated emulsions made with different protein sources in the presence of Ca²⁺. This example demonstrates that various levels of firmness can be achieved from choosing different protein sources in the presence of Ca²⁺.

### Example 8

### Preparation of Whey Protein Spread Products

This example demonstrates the preparation of a spread product using whey protein emulsion following present invention.

### Process:

1) 165 g WPI (A895) powder was dissolved in 4085 g water at 50° C. and stirring for 30 min to protein solution. The protein solution was then mixed with 750 g melted anhydrous milk fat.
2) The mixtures were homogenized at 50° C. in a two stage homogenizer, first stage and a second-stage pressures of 400 and 50 bar respectively.
3) 0.88% NaCl based on emulsion weight was added to emulsion.
4) The emulsion contained NaCl was filled to cans. The cans were retorted at 121° C. for 16 min and cooling down to room temperature. The emulsion formed the gel after retort.
5) Gel formed in the can was taken out and blended or stirred in a high speed blender to form a spread like product. Flavour, acid and other ingredients (options) can be added to gel during shearing processing to obtain an agreeable taste whey protein spread products if desired.
6) Product was filled in packages for storage.

The firmness (G′) and viscosity of spread product made from present invention and comparison products (cheese spread made by Kraft) is shown in Table 7. It is indicated that the present invention can be used to produce excellent spread products with higher firmness and viscosity at lower protein and fat contents compared with similar products in marked.

TABLE 7
Comparison of spread products made form present invention and
cheese spread made by Kraft.

| Whey protein spread | Cheese spread (Kraft) |
|---|---|
| 3.6 g protein in 100 g product | 9.5 g protein in 100 ml product |
| 15 g fat in 100 g product | 30.9 g fat in 100 ml product |
| 0.88 g NaCl 100 g product | 1.25 g sodium in 100 ml product |
| Firmness (G′): 8270 Pa | Firmness (G′): 1830 Pa |
| Shear viscosity: 4800 Pa s | Shear viscosity: 20200 Pa s |

### Example 8

### Preparation of Mayonnaise Products

This example demonstrates the preparation of mayonnaise or salad dressing-like products using whey protein emulsion following present invention.

### Process:

1. 250 g WPC (A392) powder was dissolved in 4250 g water at 50° C. and stirring for 30 min to protein solution. The protein solution was then mixed with 500 g melted anhydrous milk fat.
2. The mixtures were homogenized at 50° C. in a two stage homogenizer, first stage and a second-stage pressures of 400 and 50 bar respectively.
3. 0.88% NaCl based on emulsion weight was added to emulsion.
4. The emulsion contained NaCl was filled to cans. The cans were retorted at 121° C. for 16 min and cooling down to room temperature. The emulsion formed the gel after retort.
5. Gel formed in the can was taken out and blended or stirred in a high speed blender to form a spread like product. Flavour, acid and other ingredients (options) can be added to gel during shearing processing to obtain an agreeable taste whey protein spread products if desired.
6. Product was filled in packages for storage.

The firmness (G′) and viscosity of spread product made from present invention and comparison products: mayonnaise (Best Food), is shown in Table 8. Comparison to mayonnaise, the product of present invention has much lower fat content (10 w/w %) than that of mayonnaise (˜79% w/v) and containing no carbohydrate; slight higher protein content (4% protein come from WPC) in present invention. However, the firmness and viscosity of present invention product are more than two times higher than that of mayonnaise.

It is indicated that the present invention can be used to produce excellent mayonnaise-like products with higher firmness and viscosity at lower fat contents and without containing carbohydrate.

TABLE 8
Comparison of mayonnaise products made form present invention
and mayonnaise made by Best Food.

| Whey protein Mayonnaise | Mayonnaise (Best Food) |
|---|---|
| 4 g protein in 100 g product | 1.5 g protein in 100 ml product |
| 10 g fat in 100 g product | 78.9 g fat in 100 ml product |
| 0.88 g NaCl 100 g product | 0.665 g sodium in 100 ml product |
| Containing no carbohydrate | 1.2 g carbohydrate in 100 ml |
| | product |
| Firmness (G′): 2060 Pa | Firmness (G′): 875 Pa |
| Shear viscosity: 9210 Pa s | Shear viscosity: 4120 Pa s |

### Example 9

### Preparation of Mayonnaise and Salad Dressing Products

This example demonstrates the preparation of mayonnaise or salad dressing-like products using whey protein emulsion following present invention.

### Process:

1. 187.5 g WPC (A342) powder was dissolved in 4312.5 g water at 50° C. and stirring for 30 min to protein solution. The protein solution was then mixed with 500 g melted anhydrous milk fat.
2. The mixtures were homogenized at 50° C. in a two stage homogenizer, first stage and a second-stage pressures of 400 and 50 bar respectively.
3. 0.88% NaCl based on emulsion weight was added to emulsion.
4. The emulsion contained NaCl was filled to cans. The cans were retorted at 121° C. for 16 min and cooling down to room temperature. The emulsion formed the gel after retort.
5. Gel formed in the can was taken out and blended or stirred in a high speed blender to form a spread like product. Flavour, acid and other ingredients (options) can be added to gel during shearing processing to obtain an agreeable taste whey protein spread products if desired.
6. Product was filled in packages for storage.

The firmness (G′) and viscosity of spread product made from present invention and comparison products: salad dressing (Eta), is shown in Table 9. Comparison to salad dressing, the product of present invention has slight lower fat content (10 w/w %) than that of salad dressing (˜12% w/v), containing no carbohydrate in present product but ˜27% carbohydrate in salad dressing; slight higher protein content (3% protein come from WPC) in present invention comparing to ˜1.2% protein in salad dressing. However, the firmness and viscosity of present invention product are much higher than that of mayonnaise (Table 9).

It is indicated that the present invention can be used to produce excellent salad dressing-like products with higher firmness and viscosity at lower fat contents and without containing carbohydrate.

TABLE 9
Comparison of salad dressing products made form present invention
and salad dressing made by Eta.

| Whey protein salad dressing | Salad dressing (Eta) |
|---|---|
| 3 g protein in 100 g product | 1.2 g protein in 100 ml product |
| 10 g fat in 100 g product | 11.9 g fat in 100 ml product |
| 0.88 g NaCl 100 g product | 0.965 g sodium in 100 ml product |
| Containing no carbohydrate | 27.4 g carbohydrate in 100 ml |
| | product |
| Firmness (G′): 387 Pa | Firmness (G′): 118 Pa |
| Shear viscosity: 1910 Pa s | Shear viscosity: 1390 Pa s |

### Example 10

### Addition of Sheared Emulsion Gel in Rennet Casein Based Processed Cheese for Enhancing the Firmness

### Ingredients

Rennet casein supplied by Fonterra Co-operative Group Ltd.

WPC (ALACEN 392)

Milkfat

TSC, Salt, Citric acid

TABLE 10
formula of imitation cheese

| Ingredients | Control 1 | WPCSEG | Control 2 |
|---|---|---|---|
| Rennet casein (g) | 6.6 | 4.4 | 6.24 |
| WPC emulsion (g) | | | |
| WPC sheared | | 10 | |
| emulsion gel (g) | | | |
| WPC (g) | | | 0.36 |
| Milk fat (g) | 7.5 | 4.95 | 7.5 |
| TSC (g) | 0.80 | 0.53 | 0.80 |
| Salt (g) | 0.3 | 0.2 | 0.3 |
| Citric acid (g) | 0.25 | 0.25 | 0.25 |
| Water (g) | 14.55 | 9.60 | 14.55 |

Control 1: normal rennet casein process cheese formulation.
WPCSEG: process cheese with sheared emulsion gel made with WPC.
Control 2. process cheese with addition of WPC.
Cheese were processed at RVA, conditions: 800 rpm, 90° C. for 10 min.

Preparation of sheared emulsion gel: 3.6% proteins (WPC A392), 15 w/w % oil/milk fat, water, homogenization at 450/50 bar, 50° C., pass through twice. After the homogenising the mixture, 150 mM (0.88%) NaCl was added to emulsion. Emulsion in the presence of NaCl was then filled into metal cans and retorted at 121° C. for 16 min. The emulsions were then cooled down to room temperature in a water bath. The emulsion gel was removed and then blended in a high speed blender to form sheared emulsion gel.

TABLE 11
Results of pH, moisture and texture properties of processed cheese

| | Control 1 | WPCSEG | Control 2 |
|---|---|---|---|
| Protein (%) | 22 | 16 | 22 |
| Fat (%) | 25 | 22 | 25 |
| pH | 5.90 | 5.80 | 5.84 |
| Moisture (%) | 49.36 | 59.41 | 49.24 |
| Firmness G′ (Pa) at 20° C. | 24600 | 41260 | 24120 |

Table 11 shows that the firmness (G′) of process cheese containing sheared emulsion gel made with WPC were higher than that of normal process cheese (control 1) containing no emulsions, although the protein and fat content were lower process cheese containing sheared emulsion gel than those in normal process cheese. In addition, the process cheese containing sheared emulsion gel also have higher firmness (G′) than that of process cheese containing the same whey protein concentration but made without forming a sheared emulsion gel (control 2). This indicates that the whey protein-stabilised emulsions formed a firm structure with casein matrix during processing to enhance the firmness of process cheese.

This example demonstrates that the sheared emulsion gel can be used to achieve as a thick ingredient in promoting the texture and structure of solid or semi-solid food products such as process cheese.

### Example 11

### Addition of Sheared Emulsion Gel in Acid Gel or Yoghurt for Enhancing the Firmness

### Process:

Preparation of acid gel: Skim milk powder (Fonterra Co-operative Group Limited, Auckland) was recombined with water to an aimed protein content of 3.4%. The skim milk was two-stage homogenized (150/50 bar) (APV Rannie Lab) and heat treated (in 20 min from 50° C. to 90° C., hold-time. 13 min at 90° C.) in a steam bath. After heat treatment, the milk was cooled, 0.01% w/w sodium azide (Sigma) was added as a preservative, and the milk was stored over night at refrigeration conditions.

The milk was acidified by adding 1.65% w/w glucono-δ-lactone (Sigma) in order to reach pH 4.2 after incubation at 42° C. for 5.5 hours. After incubation, the acid gel was cooled in ice water to 20-25° C. and stirred a few times by hand. The acid gel was smoothened using an UltraTurrax for 4 min at low speed.

Preparation of sheared emulsion gel: 3.6% proteins (WPC A392), 10 w/w % oil/milk fat, water, homogenization at 450/50 bar, 50° C., pass through twice. After the homogenising the mixture, 150 mM (0.88%) NaCl was added to emulsion. Emulsion in the presence of NaCl was then filled into metal cans and retorted at 121° C. for 16 min. The emulsions were then cooled down to room temperature in a water bath. The emulsion gel was removed and then blended in a high speed blender to faun sheared emulsion gel.

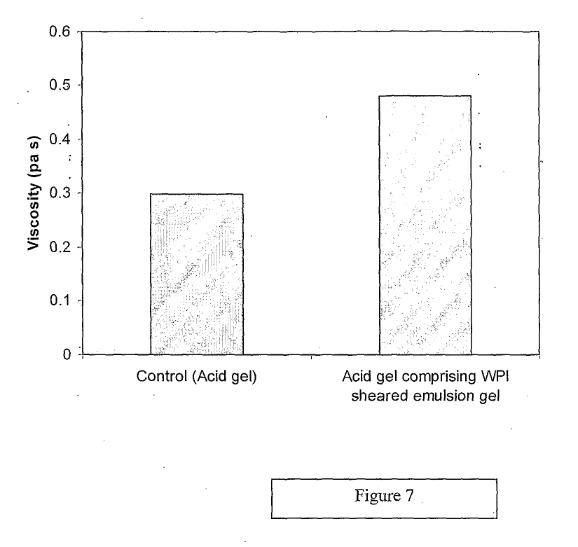

Mixing sheared emulsion gel with acid gel: At ambient temperature, above sheared emulsion gel was mixed with the stirred acid gels in ratio 1:9. The sheared emulsion gel was incorporated into the stirred acid gels by using the UltraTurrax for ˜30 s at low speed. The combined sheared emulsion gel-acid gel and control sample (acid gel) were stored for 6 days at refrigeration temperature until viscosity measurements were perfomed. Viscosities were measured using a Paar Physica MCR301 (Anton Paar) equipped with a Couette geometry (diameter outer cylinder=27 mm and diameter inner cylinder=24 mm) in the shear rate 53.3 s⁻¹. Incorporation of WPC sheared emulsion gel in the acid gel resulted in an about 20% increase in viscosity (FIG. 7).

This example demonstrates that the sheared emulsion gel can be used to achieve as a thick ingredient in promoting the texture and structure of solid or semi-solid food products such as acid gel or yoghurt.

### Utility

Those skilled in the art will appreciate that:
These gels could be prepared from a wide range of:
   Protein/water/oil compositions
   Temperature/time combinations to get gels
The emulsions can include oil-soluble materials
One can add flavours, colours, and many other ingredients that can improve the qualities of these sheared emulsion gels.

These features can be applied in products where there is a need for lower fat levels than normal. In a low fat mayonnaise can be made. Currently the level of fat in mayonnaise is at least 30% oil. This invention demonstrates that a fat level of ˜5% oil can be manufactured. Other cream products such as reduced fat dipping and spreads normally contain high percentages of fat/oil. This invention offers low fat alternatives. In general, the invention following benefits and applications:
Able to pump and dispense while low viscosity (at high shear), but then is “thick” at lower shear (such as standing or during eating).
Mayonnaise
Dips
Sauces
Spreads (e.g. low fat)
Sour creams
Cultured creams
Added into soups
Benefit—no oil-off
Reasonably temperature stable.
Potentially make a UHT version
Potentially a fat mimetic
   Dilution and adding to other foods
   Reduced creams etc.
   Caramels etc.

Any discussion of documents, acts, materials, devices or the like that has been included in the present specification is solely for the purpose of providing a context for the present invention. It is not to be taken as an admission that any or all of these matters focus part of the prior art base or were common general knowledge in the field relevant to the present invention as it existed before the priority date.

The above examples are illustrations of the practice of the invention. It will be appreciated by those skilled in the art that the invention can be carried out with numerous modifications and variations. For example, the emulsion can show variations in protein concentration and pH, the methods of emulsification can be varied, and the oils or fats and whey protein sources and heating steps can also be varied.

1. A method for preparing a viscoelastic fluid comprising:
(a). mixing oil or fat or a mixture of oil and fat with an aqueous medium to form an oil-in-water emulsion comprising 2% to 12% (w/w) of protein that can form a heat-set gel and 5% to 40% (w/w) oil or fat or a mixture of oil and fat, and homogenising the mixture at a pressure in the range 100 to 2000 bar;
(b). heating the homogenised emulsion to 50° C. to 200° C. without allowing a gel to form, for a period sufficient to denature the proteins;
(c). optionally cooling;
(d). allowing the heat-treated emulsion to form a gel by a method selected from adding a salt, and acidification; and
(e). subjecting the gel to shearing to form a viscoelastic fluid.

2. A method for preparing a viscoelastic fluid comprising:
(a). mixing oil or fat or a mixture of oil and fat with an aqueous medium to form an oil-in-water emulsion comprising 2% to 12% (w/w) of protein that can form a heat-set gel and 5% to 40% (w/w) oil or fat or a mixture of oil and fat, and homogenising the mixture at a pressure in the range 100 to 2000 bar;
(b). heating the emulsion to 50° C. to 200° C. for a period sufficient to denature the proteins and form a gel;
(c). optionally cooling; and
(d). subjecting the gel to shearing to form a viscoelastic fluid,
wherein the heating is carried out either in the presence of a salt or at a pH of less than 5.5, preferably less than 5.0.

3. A method for preparing a viscoelastic fluid comprising:
(a). heating aqueous protein to 50° C. to 200° C. for a period sufficient to denature the proteins;
(b). mixing the heat treated aqueous protein with oil or fat or mixture of both, wherein the mixture comprises 2% to 12% (w/w) whey protein and 5% to 40% (w/w) oil or fat and homogenising the mixture at a pressure in the range 100 to 2000 bar to form a gelled oil-in-water emulsion;
(c). optionally cooling;
(d). allowing the emulsion to form a gel by a method selected from adding a salt, and acidification;
(e). shearing the gel to form a viscoelastic fluid;

4. A method as claimed in claim 1 wherein the viscoelastic fluid is transferred to a plurality of containers before the viscosity returns to that of the unsheared state.

5. A method as claimed in claim 4 wherein the plurality of different containers contain different ingredients allowing manufacture of a range of different products.

6. A method as claimed in claim 1 wherein the product is a spread.

7. A method as claimed in claim 1 wherein the protein is selected from the group of proteins consisting of whey proteins, soy proteins, myofibrillar (skeletal/meat) proteins, egg proteins and blood proteins.

8. A method as claimed in claim 7 wherein the protein is whey protein, soy protein or a mixture of both.

9. A method as claimed in claim 1 wherein the protein content of the emulsion is 2% to 10% (w/w).

10. A method as claimed in claim 9 wherein the protein is whey protein.

11. A method as claimed in claim 10 wherein the whey proteins are provided from a whey protein isolate (WPI) or a whey protein concentrate (WPC).

12. A method as claimed in claim 1 wherein the oil or fat is present in an amount of 10% to 25% (w/w).

13. A method as claimed in claim 1 wherein the oil or fat is vegetable oil or milk fat.

14. A method as claimed in claim 1 wherein the heating is at a temperature in the range 70° C. to 200° C.

15. A method as claimed in claim 1 wherein gel formation is enhanced by including inorganic ions within the emulsion or the mixture used to form the emulsion.

16. A method as claimed in claim 15 wherein the ions are selected from calcium ions and sodium ions.

17. A method as claimed in claim 16 wherein ions are provided by sodium chloride or calcium chloride.

18. A method as claimed in claim 17 wherein exogenous sodium chloride is added to provide a concentration of exogenous sodium chloride of 10 to 300 mM.

19. A method as claimed in claim 18 wherein exogenous calcium chloride is used to provide a concentration of exogenous soluble calcium chloride of 4 to 20 mM.

20. A method as claimed in claim 1 wherein the pH of the gel sheared is in the range 4.0 to 7.5.

21. A method as claimed in claim 20 wherein the pH is in the range 5.5 to 7.5 or 4.0 to 4.5.

22. A method as claimed in claim 2 wherein the viscoelastic fluid is transferred to a plurality of containers before viscosity returns to that of the unsheared state.

23. A method as claimed in claim 22 wherein the plurality of different containers contain different ingredients, allowing manufacture of a range of different products.

24. A method as claimed in claim 2 wherein the protein is whey protein.

25. A method as claimed in claim 3 wherein the viscoelastic fluid is transferred to a plurality of containers before the viscosity returns to that of the unsheared state.

26. A method as claimed in claim 25 wherein the plurality of different containers contain different ingredients, allowing manufacture of a range of different products.

27. A method as claimed in claim 3 wherein the protein is whey protein.
